(19) United States
(12) Patent Application Publication
(10) Pub. No.: US 2024/0104354 A1
(43) Pub. Date: Mar. 28, 2024

(54) VARIATIONAL METHOD OF MAXIMIZING CONDITIONAL EVIDENCE FOR LATENT VARIABLE MODELS

(71) Applicant: INTERNATIONAL BUSINESS MACHINES CORPORATION, Armonk, NY (US)

(72) Inventors: Kohei Miyaguchi, Tokyo (JP); Takayuki Katsuki, Tokyo (JP); Akira Koseki, Tokyo (JP); Toshiya Iwamori, Tokyo (JP)

(21) Appl. No.: 17/942,454

(22) Filed: Sep. 12, 2022

(51) Int. Cl. G06N 3/04; G06N 3/08

(52) U.S. Cl. CPC G06N 3/0472; G06N 3/08

(57) ABSTRACT

A computer-implemented method is provided for learning with incomplete data in which some of entries are missing. The method includes acquiring an incomplete set of covariates x̅ including incomplete features \tilde{x} and an incomplete pattern m indicating missing entries of the incomplete set of covariates \tilde{x}. The method further includes obtaining, by a hardware processor, a predictive distribution p_{θ}(y|x̅) of an outcome y by using the incomplete set of covariates x̅ and a parameter θ, the parameter θ being unknown. A learning of the parameter θ includes performing a maximization by maximizing a stochastically approximated conditional evidence lower bound. The stochastically approximated conditional evidence lower bound includes a density ratio which is controlled by transforming a portion of parameters of the stochastically approximated conditional evidence lower bound to keep a gradient of the stochastically approximated conditional evidence lower bound below a threshold during the maximization.

### STATEMENT REGARDING PRIOR DISCLOSURES BY THE INVENTOR OR A JOINT INVENTOR

The following disclosure(s) are submitted under 35 U.S.C. § 102(b)(1)(A):

DISCLOSURE(S): “Variational Inference for Discriminative Learning with Generative Modeling of Feature Incompletion”, by Kohei Miyaguchi, Takayuki Katsuki, Akira Koseki, and Toshiya Iwamori, International Conference on Learning Representations (ICLR), Oct. 5, 2021.

### BACKGROUND

The present invention generally relates to learning with incomplete data, and more particularly to a variational method of maximizing conditional evidence for latent variable models.

Electronic health records (EHRs) present a wealth of data that are vital for improving patient-centered outcomes, although the data can present significant statistical challenges. In particular, EHR data includes substantial missing information that if left unaddressed could reduce the validity of conclusions drawn. Properly addressing the missing data issue in EHR data is complicated by the fact that it is sometimes difficult to differentiate between missing data and a negative value. For example, a patient without a documented history of heart failure may truly not have disease or the clinician may have simply not documented the condition.

Generative modeling is known to be useful in this context because such generative modeling can learn predictive distributions of survival times and can handle missing values. However, it is also known that training generative models with respect to the pure objective of prediction can be intractable if the models are complex.

### SUMMARY

According to aspects of the present invention, a computer-implemented method is provided for learning with incomplete data in which some of entries are missing. The method includes acquiring an incomplete set of covariates x̅ including incomplete features \tilde{x} and an incomplete pattern m indicating missing entries of the incomplete set of covariates \tilde{x}. The method further includes obtaining, by a hardware processor, a predictive distribution p_{θ}(y|x̅) of an outcome y by using the incomplete set of covariates x̅ and a parameter θ, the parameter θ being unknown. A learning of the parameter θ includes performing a maximization by maximizing a stochastically approximated conditional evidence lower bound. The stochastically approximated conditional evidence lower bound includes a density ratio which is controlled by transforming a portion of parameters of the stochastically approximated conditional evidence lower bound to keep a gradient of the stochastically approximated conditional evidence lower bound below a threshold during the maximization.

According to other aspects of the present invention, a computer program product is provided for learning with incomplete data in which some of entries are missing. The computer program product includes a non-transitory computer readable storage medium having program instructions embodied therewith. The program instructions are executable by a computer to cause the computer to perform a method. The method includes acquiring, by a hardware processor of the computer, an incomplete set of covariates x̅ including incomplete features \tilde{x} and an incomplete pattern m indicating missing entries of the incomplete set of covariates \tilde{x}. The method further includes obtaining, by the hardware processor, a predictive distribution p_{θ}(y|x̅) of an outcome y by using the incomplete set of covariates x̅ and a parameter θ, the parameter θ being unknown. A learning of the parameter θ includes performing a maximization by maximizing a stochastically approximated conditional evidence lower bound. The stochastically approximated conditional evidence lower bound includes a density ratio which is controlled by transforming a portion of parameters of the stochastically approximated conditional evidence lower bound to keep a gradient of the stochastically approximated conditional evidence lower bound below a threshold during the maximization.

According to still other aspects of the present invention, a computer processing system is provided for learning with incomplete data in which some of entries are missing. The computer processing system includes a memory device for storing program code. The computer processing system further includes a hardware processor operatively coupled to the memory device for running the program code to acquire an incomplete set of covariates x̅ including incomplete features \tilde{x} and an incomplete pattern m indicating missing entries of the incomplete set of covariates \tilde{x}. The hardware processor further runs the program code to obtain a predictive distribution p_{θ}(y|x̅) of an outcome y by using the incomplete set of covariates x̅ and a parameter θ, the parameter θ being unknown. A learning of the parameter θ includes performing a maximization by maximizing a stochastically approximated conditional evidence lower bound. The stochastically approximated conditional evidence lower bound includes a density ratio which is controlled by transforming a portion of parameters of the stochastically approximated conditional evidence lower bound to keep a gradient of the stochastically approximated conditional evidence lower bound below a threshold during the maximization.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of a computing environment, in accordance with an embodiment of the present invention;

FIG. 2 is a block diagram showing an exemplary discriminative variational autoencoder (DVAE), in accordance with an embodiment of the present invention;

FIG. 3 is diagram showing an exemplary computation graph of the DVAE of FIG. 2, in accordance with an embodiment of the present invention;

FIGS. 4-5 are flow diagrams showing an exemplary stable variational method of conditional evidence maximization with latent variable models, in accordance with an embodiment of the present invention;

FIG. 6 is a block diagram of components of a computing system including a computing device employing the method 400 of FIGS. 4-5 for training the DVAE via an artificial intelligence (AI) accelerator chip, in accordance with an embodiment of the present invention;

FIG. 7 is a diagram showing practical applications for employing the DVAE via an AI accelerator chip, in accordance with an embodiment of the present invention;

FIG. 8 is a block/flow diagram of a practical application including health care records for employing the DVAE via the AI accelerator chip, in accordance with an embodiment of the present invention; and

FIG. 9 is a diagram illustrating an algorithm for CELBO maximization with Surrogate Parameterization, in accordance with an embodiment of the present invention.

### DETAILED DESCRIPTION

Embodiments of the present invention are directed to a variational method of maximizing conditional evidence for latent variable models.

The exemplary methods are concerned with the issue of learning with incomplete data, which often arises in real-life data due to the lack of data collecting resources. In particular, electronic health records (EHR) is an example of such datasets. There are various types of data to describe patients such as demographic characteristics, medical measurement data obtained with various instruments and historical collection of those, while most of them are not necessarily available with all the patients due to limited data collecting resources, non-standardized medical equipment and legal and/or privacy concerns.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

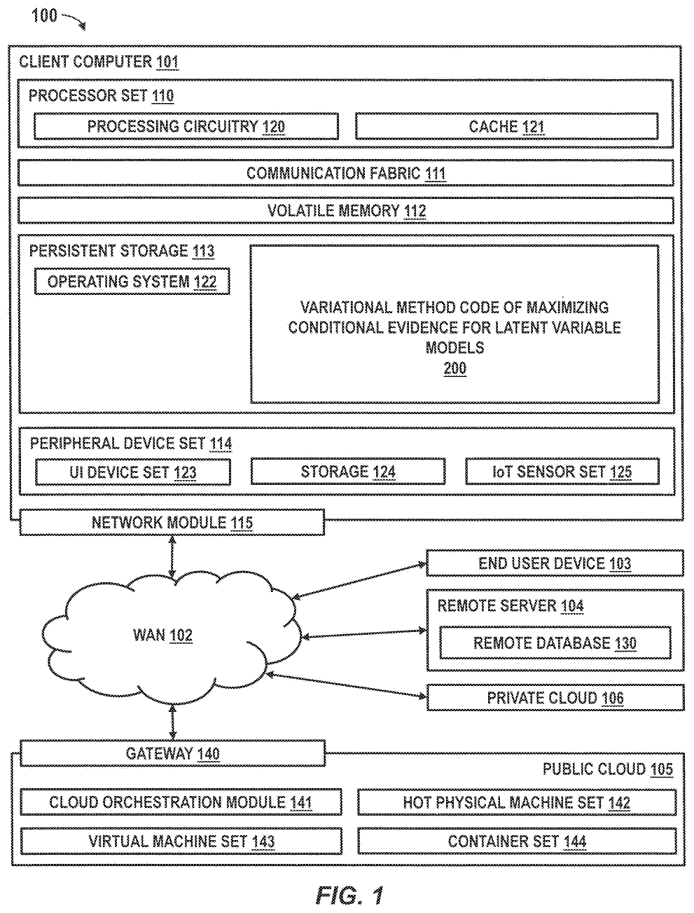

FIG. 1 is a block diagram of a computing environment 100, in accordance with an embodiment of the present invention.

Computing environment 100 contains an example of an environment for the execution of at least some of the computer code involved in performing the inventive methods, such as variational method code of maximizing conditional evidence for latent variable models 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

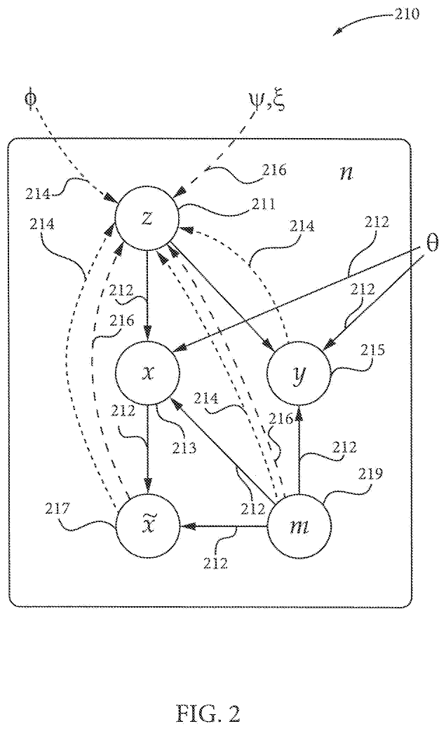

FIG. 2 shows an exemplary discriminative variational autoencoder (DVAE) 210, in accordance with an embodiment of the present invention.

The exemplary embodiments present the discriminative variational autoencoder (DVAE), which performs DIGM with incomplete covariates. DVAE includes a generative network, two variational networks, and a surrogate network as shown in FIG. 2.

Regarding the generative probabilistic model, the exemplary embodiments suppose that the joint probability density of (y, x) given m is modeled with a generative neural network θ. That is, with some latent noise variable z and the corresponding prior p(z),

p_{θ}(y,\tilde{x}|m)=∫p(z)pθ(y,x|z,m)p(\tilde{x}|x,m)dxdz

where x∈ [symbol] ^{d} denotes the complete covariates, p_{θ}(y, x|z):=p(y, x|θ(z)) is the density given by the neural network θ, and

$$p ( \tilde{x} \vert x , m ) := {\prod }_{j = 1}^{d} δ ( {\tilde{x}}_{j} - ( 1 - {m}_{j} ) {x}_{j} )$$

is corresponding to the masking process. Here, δ denotes Dirac's delta function. It is noted that the exemplary embodiments treat m as a conditional since there is no interest in the distribution of missing patterns. For simplicity, the exemplary embodiments further limit the scope to where the individual covariates xⱼ and the target y are mutually conditionally independent given z and m, which allows the exemplary methods to efficiently compute some of marginal distributions,

$${p}_{θ} ( y , \tilde{x} \vert z , m ) = {p}_{θ} ( y \vert z , m ) {\prod }_{j : {m}_{j} = 0} {p}_{θ} ( {x}_{j} = {\tilde{x}}_{j} \vert z , m ) , \\ {p}_{θ} ( \tilde{x} \vert z , m ) = {\prod }_{j : {m}_{j} = 0} {p}_{θ} ( {x}_{j} = {\tilde{x}}_{j} \vert z , m ) .$$

Regarding discriminative interference, the goal of DIGM is to minimize the conditional negative log-likelihood with respect to some training data [symbol] :={(yⁱ,x̅ⁱ)}_{i∈[n]}, given by [symbol] ₙ(θ):=Σᵢ₌₁ⁿ [symbol] ⁱ(θ), where [symbol] ⁱ(θ):=−lnp_{θ}(yⁱ, x̅ⁱ) denotes the individual loss of the i-th instance (yⁱ, x̅ⁱ) ∈ [symbol] × [symbol] ^{d}, corresponding to a patient in the dataset.

In the following, the exemplary methods introduce an approximation of the individual losses [symbol] ⁱ(θ) and the exemplary methods omit the patient index i for the ease of exposition.

Now, it is observed that [symbol] (θ)=−lnp_{θ}(y, x̅|m)+lnp_{θ}(x̅|m).

Since both terms in the right-hand side include intractable integrals inside, the exemplary methods resort to the variational inference framework. In particular, the exemplary methods bound [symbol] (θ) from above with a quantity that is computationally tractable and readily usable with gradient-based optimization algorithms. To this end, the exemplary methods introduce three neural networks φ, ψ, and ξ which are trained together with the generative network θ.

Regarding the Joint Evidence Lower Bound (JELBO), the first term is bounded with the standard variational lower bound with a negative sign on both sides,

$$\begin{matrix}- ln {p}_{θ} ( y , \tilde{x} \vert m ) \leq - ln {p}_{θ} ( y , \tilde{x} \vert m ) + {D}_{KL} ( {q}_{ϕ} ( Z \vert y , \overline{x} ) ‖ {p}_{θ} ( Z \vert y , \overline{x} ) ) \\ = {𝔼}_{z \sim {q}_{ϕ} ( \cdot \vert y , \overline{x} )} [ - ln \frac{p ( z ) {p}_{θ} ( y , \tilde{x} \vert z , m )}{{q}_{ϕ} ( z \vert y , \overline{x} )} ] \\ = : - {ℒ}_{JELBO} ( θ , ϕ )\end{matrix}$$

where D_{KL}(q(Z)∥p(Z)):=∫dz q(z) ln[q(z)/p(z)] is the Kullback-Leibler divergence and q_{ϕ}(z|y,x̅):=q(z|ϕ(y, x̅)) is a conditional density function defined by φ. [symbol] _{JELBO}(θ, φ) is referred to as the joint evidence lower bound (JELBO). Since JELBO is an expectation of a tractable function, the exemplary methods approximate JELBO with Monte-Carlo sampling.

JELBO is thus defined with two probability networks, a decoder θ, which defines joint evidence ln p_{θ}(\tilde{x}, y|m) and an encoder ϕ, which lower-bounds the evidence via KL divergence. The expectation is unbiasedly estimated with Monte-Carlo sampling.

Regarding the Marginal Evidence Upper Bound (MEUBO), to bound the second term, the exemplary methods start with applying the χ-evidence upper bound (CUBO). For any real numbers α >1, CUBO is derived as follows:

$$\begin{matrix}- ln {p}_{θ} ( \tilde{x} \vert m ) \leq - ln {p}_{θ} ( \tilde{x} \vert m ) + ( 1 - {α}^{- 1} ) {D}_{α} ( {p}_{θ} ( Z \vert \overline{x} ) ‖ {q}_{ψ} ( Z \vert \overline{x} ) ) \\ = \frac{1}{α} {𝔼}_{z \sim {q}_{ψ} ( \cdot \vert \overline{x} )} [ ln \frac{p ( z ) {p}_{θ} ( \tilde{x} \vert z , m )}{{q}_{ψ} ( z \vert \overline{x} )} ] \\ = : {ℒ}_{CUBO} ( θ , ψ )\end{matrix} , \\ where {D}_{α} ( p ( Z ) ‖ q ( Z ) ) := \frac{1}{α - 1} ln \int {dzp}^{α} ( Z ) {q}^{1 - α} ( z )$$

denotes the α-Renyi divergence and qψ(z|x̅):=q(z|ψ(x̅) is a conditional density function defined by ψ. The exemplary methods consider the case where α=2 in particular, but the following method can be equally applicable to the other cases.

Note here, unlike JELBO, CUBO is not unbiasedly approximated because of the logarithm wrapping the expectation. To work around this issue, the exemplary embodiments introduce an additional divergence measure referred to as the exponential divergence measure ψ_{α}(t):=(e^{αt}−αt−1)/α,t ∈ [symbol] , along with a surrogate variational network ξ: [symbol] ^{d}→ [symbol] .

It is observed that Ψα(t)≥0 for all t∈ [symbol] and thus:

$$\begin{matrix}{ℒ}_{CUBO} ( θ , ψ ) \leq {ℒ}_{CUBO} ( θ , ψ ) + {Ψ}_{α} ( {ℒ}_{CUBO} ( θ , ψ ) - ξ ( \overline{x} ) ) \\ = \frac{{e}^{- αξ ( \overline{x} )}}{α} {{𝔼}_{z \sim {q}_{ψ} ( \cdot \vert \overline{x} )} [ \frac{p ( z ) {p}_{θ} ( \tilde{x} \vert z , m )}{{q}_{ψ} ( z \vert \overline{x} )} ]}^{α} + ξ ( \overline{x} ) - \frac{1}{α} \\ = : {ℒ}_{MEUBO} ( θ , ψ , ξ )\end{matrix} ,$$

where the right-hand side is referred to as the marginal evidence upper bound (MEUBO). Note that MEUBO can be unbiasedly approximated with Monte-Carlo estimation and the inequality is tight, if and only if, ξ(x̅)= [symbol] _{CUBO}(θ, ψ).

Thus, CUBO is defined with 2 probability networks, that is, decoder θ, which defines the marginal evidence ln p_{θ}(x̅) and encoder ψ, which upper-bounds the evidence via α-Renyi divergence (α>1). However, the expectation cannot be unbiasedly estimated with Monte-Carlo sampling because of the logarithm wrapping the expectation. To solve such issue, the exemplary embodiments construct MEUBO, an upper bound on CUBO, with an exponential divergence measure and a surrogate network ξ:x̅ [symbol] ξ(x̅)∈ [symbol] . Unbiased Monte-Carlo estimation is now possible.

Regarding Discriminative Variational Autoencoders (DVAE), combining JELBO and MEUBO, an upper bound of the objective function can be had:

[symbol]

_{DVAE}(θ,ϕ,ψ,ξ):= [symbol] _{MEUBO}(θ,ψ,ξ)− [symbol] _{JELBO}(θ,ϕ)≥ [symbol] (θ).

The objective gap is tight if the variational networks are expressive enough, e.g.,

q_{ϕ}(z|y,x̅)≈p_{θ}(z|y,x̅),q_{ψ}(z|x̅)≈p_{θ}(z|x̅) and ξ(x̅)≈ln p(\tilde{x}|m).

Since both JELBO and MEUBO can be unbiasedly approximated, the exemplary method can employ stochastic gradient-based optimization methods to minimize [symbol] _{DVAE}. Specifically, JELBO for the i-th instance is approximated with

$${\hat{ℒ}}_{JELBO}^{i} ( θ , ϕ ) := \frac{1}{{k}_{ϕ}} {\sum }_{z ∈ {S}_{ϕ}} ln \frac{p ( z ) {p}_{θ} ( {y}^{i} , {\tilde{x}}^{i} \vert z , m )}{{q}_{ϕ} ( z \vert {y}^{i} , {\overline{x}}^{i} )}$$

and MEUBO for the i-th instance is approximated with:

$${\hat{ℒ}}_{MEUBO}^{i} ( θ , ψ , ξ ) := \frac{{e}^{- α ξ ( {\overline{x}}^{i} )}}{α {k}_{ψ}} {\sum }_{z ∈ {S}_{ψ}} {[ \frac{p ( z ) {p}_{θ} ( {\tilde{x}}^{i} \vert z , m )}{{q}_{ψ} ( z \vert {\overline{x}}^{i} )} ]}^{α} + ξ ( {\overline{x}}^{i} ) - \frac{1}{α}$$

where Sϕ and Sψ are Monte-Carlo samples drawn from q_{ϕ}(z|yⁱ, x̅ⁱ) and q_{ψ}(z|x̅ⁱ) with |S_{ϕ}|=k_{ϕ} and |S_{ψ}|=k_{ψ}, respectively. The gradients of these functions are taken with any standard automatic differentiation libraries, using, e.g., the re-parametrization trick or the REINFORCE trick.

Finally, since the actual objective function is the summation of individual losses [symbol] _{DVAE}:= [symbol] _{MEUBO}ⁱ− [symbol] _{JELBO} over all the patients, the exemplary embodiments can draw a minibatch of patients of size k m b for each iteration. The exemplary methods refer to the resulting inference method as the discriminative variational autoencoder (DVAE), which is identified with the quadruple of neural networks (θ, ϕ, ψ, ξ).

Regarding the Importance-Weighted MEUBO, the exemplary methods also consider an improvement over the MEUBO estimate to reduce the variance.

The new estimate is given by introducing the importance sampling with respect to the midpoint distribution q̅_{ψ}(z|x̅):=(p(z)+q_{ψ}(z|x̅))/2,

$${\hat{ℒ}}_{IW - MEUBO} ( θ , ψ , ξ ) := \frac{{e}^{- α ξ ( \overline{x} )}}{α {k}_{ψ}} {\sum }_{z ∈ {S}_{ψ}} \frac{{p}^{α} ( z ) {p}_{θ}^{α} ( \tilde{x} \vert z , m )}{{q}_{ψ}^{α - 1} ( z \vert \overline{x} ) {\overline{q}}_{ψ} ( z \vert \overline{x} )} + ξ ( \overline{x} ) - \frac{1}{α}$$

where S_{ψ} is drawn from q̅_{ψ}(z|x̅). Note that the exemplary methods can still use the reparametrization trick with [symbol] _{IW-MEUBO} since the proposal distribution is a mixture of a constant distribution p( [symbol] ) and a reparametrizable distribution q_{ψ}(z|x̅). Moreover, the importance-weighted estimate behaves better than the original one in terms of their variances:

Regarding a first theorem:

Let V:=Var[ [symbol] _{MEUBO}(θ, ψ, ξ)] and V_{IW}:=Var[ [symbol] _{IW-MEUBO}(θ, ψ, ξ)] denote the variances of the estimates, respectively.

Also let Δ:= [symbol] _{DVAE}(θ, ϕ, ψ, ξ)− [symbol] (θ) denote the objective gap. Then

$${𝒱}_{IW} \leq ( 1 ∧ \frac{β}{{( {k}_{ψ} 𝒱 )}^{\frac{1}{2 α}}} ) [ 2 𝒱 + \frac{{e}^{\sqrt{8 α Δ}}}{{k}_{ψ}} ] ,$$

where ∧ denotes the minimum operator and β:=2e^{-ξ(x̅)}sup_{z}p_{θ}(\tilde{x}| z, m).

In other words, the variance of [symbol] _{IW-MEUBO} is asymptotically smaller than [symbol] _{MEUBO} by an exponent of

$$1 - \frac{1}{2 α} ,$$

while, in a non-asymptotic sense, it is still favorable up to an additive and a multiplicative constants if the objective gap Δ is bounded. In particular, [symbol] _{IW-MEUBO} is stabler than [symbol] _{MEUBO} in bad conditions, e.g., where q is largely misspecified, owing to the exponent

$$1 - \frac{1}{2 α} < 1.$$

Regarding the proof, let the summand of MEUBO be denoted as:

$${w}^{α} ( z ) := {[ \frac{p ( z ) {p}_{θ} ( \tilde{x} \vert z , m )}{{q}_{ψ} ( z \vert \overline{x} )} ]}^{α}$$

and the importance weight as:

$$γ ( z ) := \frac{{q}_{ψ} ( z \vert \overline{x} )}{{\overline{q}}_{ψ} ( z \vert \overline{x} )} .$$

Then,

v=A( [symbol] _{z˜ψ}[w^{2a}(z)]−C),

v_{IW}=A( [symbol] _{z˜ψ}[γ(z)w^{2a}(z)]−C),

where

$$A := \frac{{e}^{- 2 α ξ ( \overline{x} )}}{{α}^{2} {k}_{ψ}} , C := {e}^{2 α {ℒ}_{CUBO} ( θ , ψ )}$$

and [symbol] _{z˜ψ} is a shorthand for the expectation with respect to z˜q_{ψ}(z|x̅).

Now it is observed that γ(z)≤2 and thus:

$${𝒱}_{IW} \leq A ( 2 ( \frac{𝒱}{A} + C ) - C ) = 2 𝒱 + AC .$$

Moreover, the exemplary methods also have γ(z)≤2Mw⁻¹(z) for

M:=sup_{z}p(x̅|z,m).

Thus:

$$\begin{matrix}{𝒱}_{IW} \leq A ( 2 M {𝔼}_{z \sim ψ} [ {w}^{2 α - 1} ( z ) ] - C ) \\ \leq A ( 2 {M ( \frac{𝒱}{A} + C )}^{1 - \frac{1}{2 α}} - C ) ( Jensen ’ s inequality ) \\ = 2 {{MA}^{\frac{1}{2 α}} ( 𝒱 + AC )}^{1 - \frac{1}{2 α}} - AC \\ \leq 2 {M ( \frac{A}{𝒱} )}^{\frac{1}{2 α}} ( 2 𝒱 + AC ) . ( 𝒱 , A , C \geq 0 )\end{matrix}$$

Finally, the conclusion follows with the simplification on the right-hand sides,

$$A \leq \frac{{e}^{- 2 αξ ( \overline{x} )}}{{k}_{ψ}} , AC \leq \frac{1}{{k}_{ψ}} {e}^{2 α ( {ℒ}_{CUBO} ( θ , ψ ) - ξ ( \overline{x} ) )} and \\ {ℒ}_{CUBO} ( θ , ψ ) - ξ ( \overline{x} ) \leq \sqrt{\frac{2}{α} {Ψ}_{α} ( {ℒ}_{CUBO} ( θ , ψ ) - ξ ( \overline{x} ) )} \leq \sqrt{\frac{2}{α} Δ} .$$

The prediction procedure can be as follows:

Consider using an already-trained DVAE (θ, ϕ, ψ, ξ) to make a prediction on unseen patients given their incomplete covariates x̅=x̅ⁿ⁺¹.

Since the conditional density p_{θ}(y|x̅) can be intractable in general, the exemplary methods approximate it with Monte-Carlo sampling and the variational distribution q_{ψ}(z|x̅) instead. Namely, the approximated conditional distribution is given by:

$${\hat{p}}_{θ} ( y \vert \overline{x} ) := \frac{1}{{k}_{pred}} {\sum }_{s = 1}^{{k}_{pred}} δ ( y - {\hat{y}}^{s} ) , {k}_{pred} \geq 1 ,$$

where ŷ^{s}˜p_{θ}(y|\hat{z}^{s}) and \hat{z}^{s}−q_{ψ}(z|x̅), s∈[k_{pred}], are independently drawn Monte-Carlo samples. This procedure is justified as follows.

Regarding the second theorem, let p̅_{θ}(y|x̅):= [symbol] [\hat{p}_{θ}(y|x̅)] be the mean of the approximation with respect to the Monte-Carlo samples. Then, the approximation error with respect to the KL divergence is bounded with the objective gap,

$${D}_{KL} ( {p}_{θ} ( Y \vert \overline{x} ) ‖ {\overline{p}}_{θ} ( Y \vert \overline{x} ) ) \leq \frac{α}{α - 1} Δ ,$$

where Δ is defined in the first theorem.

In other words, if the variational networks are trained enough that the objective gap is small, so is the approximation error of p̅_{θ}, which is the weak large sample limit (k_{pred}→∞) of the actual predictor \hat{p}_{θ}.

The proof is provided as follows:

According to the information processing inequality, the exemplary methods have the following:

D_{KL}(p_{θ}(Y|x̅)p̅_{θ}(Y|x̅)≤D_{KL}(p_{θ}(Z|x̅)∥q_{ψ}(Z|x̅).

Moreover, by the construction of [symbol] _{MEUBO}, the exemplary methods have (1−α⁻¹)D_{α}(p_{θ}(Z|x̅)∥q_{ψ}(Z|x̅))≤Δ.

The desired result is seen by combining these two inequalities with the fact that D_{KL}(p∥q)≤D_{α}(p∥q) for all α>1.

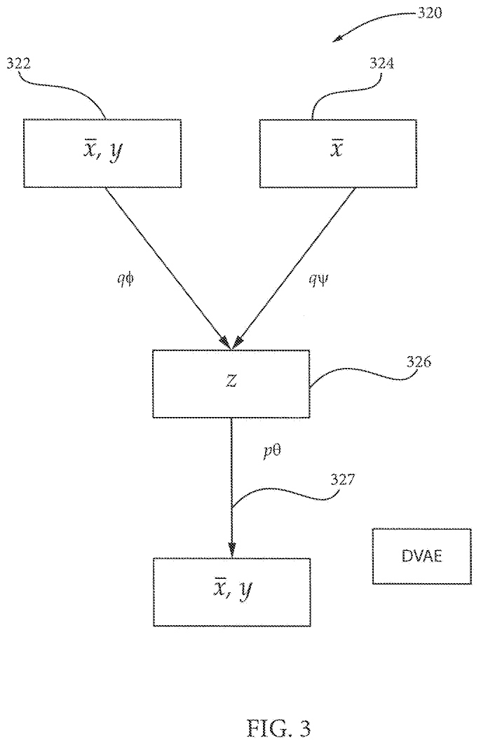

FIG. 3 is an exemplary computation graph 320 of the DVAE 210 of FIG. 2, in accordance with an embodiment of the present invention.

Referring back to FIG. 2, solid lines 212 denote the generative model p(m)p(z)p_{θ}(y, x|z, m)p(\tilde{x}|x, m), dashed lines 214 denote the variational approximation q_{ϕ}(z|y, x̅) to the intractable posterior given joint observations p_{θ}(z|y, x̅), chain lines 216 denote the variational approximation qψ(z|x̅) to the intractable posterior given marginal observations p_{θ}(z|x̅) with the help of the surrogate variational parameter ξ. The variational parameters (φ, ψ, ξ) are learned jointly with the generative model parameter θ. In FIG. 2, 211 denotes z (noise variable), 213 denotes x (complete covariates), 215 denotes y (outcome), 217 denotes \tilde{x}(incomplete covariates), and 219 denotes m (mask vector).

With reference to FIG. 3, three probability models (θ, ϕ, ψ) are combined to form a new architecture referred to as a discriminative variational autoencoder (DVAE). In other words, the decoder p_{θ}(x̅, y|z), the joint encoder p_{ϕ}(z|x̅, y), and the marginal encoder p_{ψ}(z|x̅) are combined. JELBO is computed with the decoder and the joint encoder, whereas MEUBO is computed with the decoder and the marginal encoder. In other words, the variational approximation q_{ϕ}(322) and the variational approximation q_{ψ}(324) are provided to z (326) to output the model p_{θ} (327).

Thus, a method of computing the objective of DIGM for an incomplete covariate is provided with difference of marginal evidence upper bound ( [symbol] _{MEUBO}) and joint evidence lower bound ( [symbol] _{JELBO}), and ln p_{θ}(x̅)≤ [symbol] _{MEUBO} and ln p_{θ}(x̅, y)≥ [symbol] _{JELBO}, such that [symbol] :=−ln p_{θ}(y|x̅)=ln p_{θ}(x̅)−ln p_{θ}(x̅, y)≤ [symbol] _{MEUBO}− [symbol] _{JELBO}.

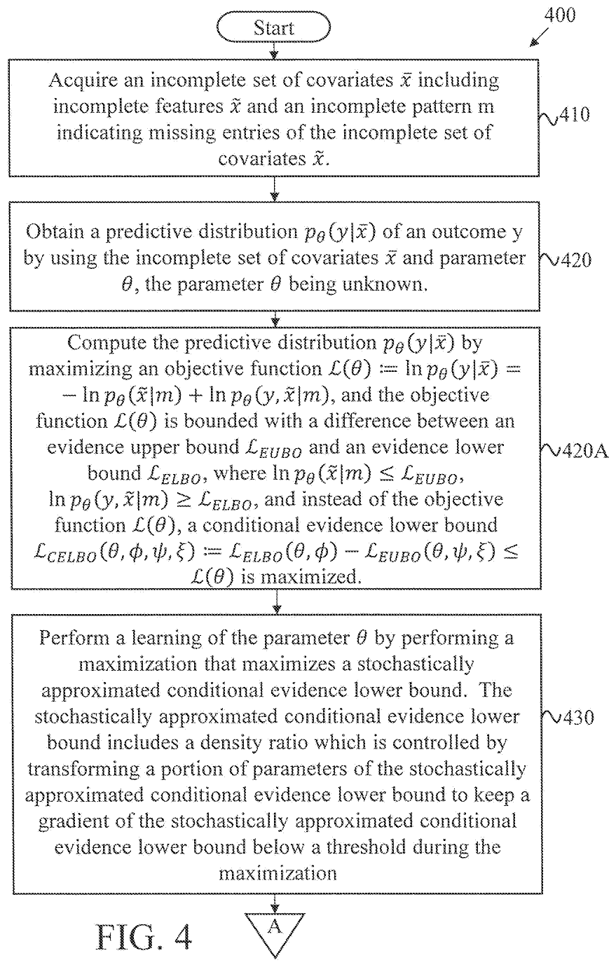

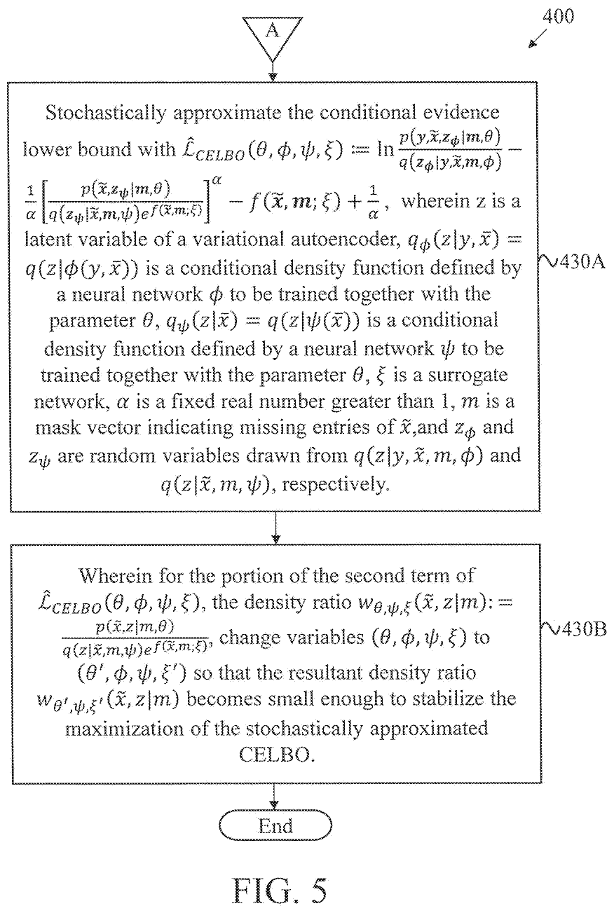

FIGS. 4-5 are flow diagrams showing an exemplary stable variational method of conditional evidence maximization with latent variable models, in accordance with an embodiment of the present invention.

At block 410, acquire an incomplete set of covariates x̅ including incomplete features \tilde{x} and an incomplete pattern m indicating missing entries of the incomplete set of covariates \tilde{x}.

At block 420, obtain a predictive distribution p_{θ}(y|x̅) of an outcome y by using the incomplete set of covariates x̅ and parameter θ, the parameter θ being unknown. In an embodiment, the outcome y is a prediction time of an adverse medical event requiring medical intervention. Of course, other outputs, as mentioned herein, are also possible given the teachings of the present invention provided herein.

In an embodiment, block 420 can include blocks 420A.

At block 420A, compute the predictive distribution p_{θ}(y|x̅) by maximizing an objective function [symbol] (θ):=ln p_{θ}(y|x̅)=−ln p_{θ}(\tilde{x}|m)+ln p_{θ}(y, \tilde{x}|m), and the objective function [symbol] (θ) is bounded with a difference between an evidence upper bound [symbol] _{EUBO} and an evidence lower bound [symbol] _{ELBO}, where ln p_{θ}(\tilde{x}|m)≤ [symbol] _{EUBO}, ln p_{θ}(y, \tilde{x}|m)≥ [symbol] _{ELBO}, and instead of the objective function [symbol] (θ), a conditional evidence lower bound [symbol] _{CELBO}(θ, ϕ, ψ, ξ):= [symbol] _{ELBO}(θ, ϕ)− [symbol] _{EUBO}(θ, ψ, ξ)≤ [symbol] (θ) is maximized.

At block 430, perform a learning of the parameter θ by performing a maximization that maximizes a stochastically approximated conditional evidence lower bound. The stochastically approximated conditional evidence lower bound includes a density ratio which is controlled by transforming a portion of parameters of the stochastically approximated conditional evidence lower bound to keep a gradient of the stochastically approximated conditional evidence lower bound below a threshold during the maximization.

In an embodiment, block 430 can include one or more of blocks 430A through 430B.

At block 430A, stochastically approximate the conditional evidence lower bound with

$${\hat{ℒ}}_{CELBO} ( θ , ϕ , ψ , ξ ) := ln \frac{p ( y , \tilde{x} , {z}_{ϕ} \vert m , θ )}{q ( {z}_{ϕ} \vert y , \tilde{x} , m , ϕ )} - {\frac{1}{α} [ \frac{p ( \tilde{x} , {z}_{ψ} \vert m , θ )}{q ( {z}_{ψ} \vert \tilde{x} , m , ψ ) {e}^{f ( \tilde{x} , m ; ξ )}} ]}^{α} - f ( \tilde{x} , m ; ξ ) + \frac{1}{α} ,$$

wherein z is a latent variable of a variational autoencoder, q_{ϕ}(z|y, x̅)=q(z|ϕ(y, x̅)) is a conditional density function defined by a neural network ϕ to be trained together with the parameter θ, q_{ψ}(z|x̅)=q(z|ψ(x̅)) is a conditional density function defined by a neural network ψ to be trained together with the parameter θ, ξ is a surrogate network, α is a fixed real number greater than 1, m is a mask vector indicating missing entries of \tilde{x}, and z_{ϕ} and z_{ψ} are random variables drawn from q(z|y, \tilde{x}, m, ϕ)) and q(z|\tilde{x}, m, ψ), respectively.

At block 430B, wherein for the portion of the second term of [symbol] _{CELBO}(θ, ϕ, ψ, ξ), the density ratio

$${w}_{θ , ψ , ξ} ( \tilde{x} , z \vert m ) := \frac{p ( \tilde{x} , z \vert m , θ )}{q ( z \vert \tilde{x} , m , ψ ) {e}^{f ( \tilde{x} , m ; ξ )}} ,$$

change variables (θ, ϕ, ψ, ξ) to (θ′, ϕ, ψ, ξ′) so that the resultant density ratio w_{θ′, ψ, ξ′}(\tilde{x}, z|m) becomes small enough to stabilize the maximization of the stochastically approximated CELBO.

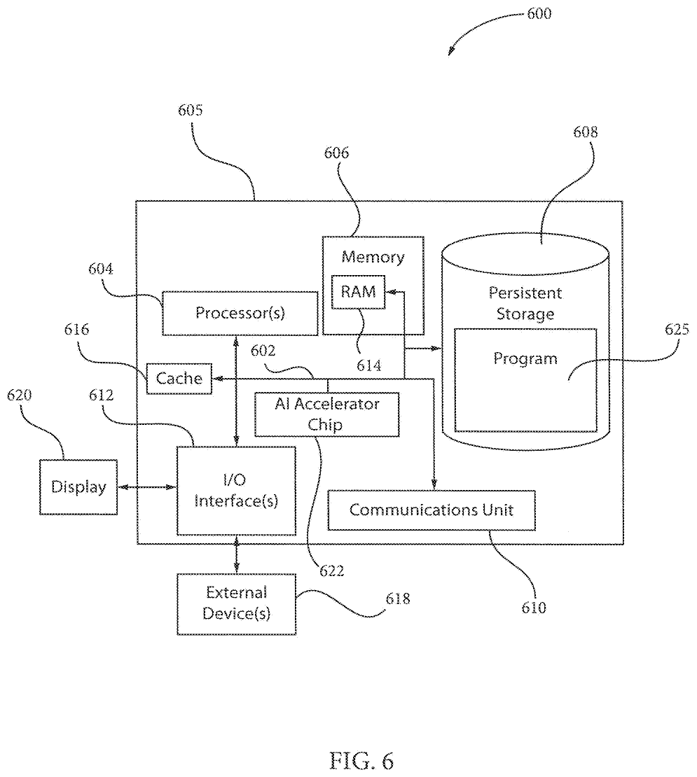

FIG. 6 is a block diagram of components of a computing system including a computing device employing the method 400 of FIGS. 4-5 for training the DVAE via an artificial intelligence (AI) accelerator chip, in accordance with an embodiment of the present invention.

FIG. 6 depicts a block diagram of components of system 600, which includes computing device 605. It should be appreciated that FIG. 6 provides only an illustration of one implementation and does not imply any limitations with regard to the environments in which different embodiments can be implemented. Many modifications to the depicted environment can be made.

Computing device 605 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606, cache memory 616, and persistent storage 608 are computer readable storage media. In this embodiment, memory 606 includes random access memory (RAM) 614. In another embodiment, the memory 606 can be flash memory. In general, memory 606 can include any suitable volatile or non-volatile computer readable storage media.

In some embodiments of the present invention, deep learning program 625 is included and operated by AI accelerator chip 622 as a component of computing device 605. In other embodiments, deep learning program 625 is stored in persistent storage 608 for execution by AI accelerator chip 622 in conjunction with one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 can also be removable. For example, a removable hard drive can be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices, including resources of distributed data processing environment. In these examples, communications unit 610 includes one or more network interface cards. Communications unit 610 can provide communications through the use of either or both physical and wireless communications links. Deep learning program 625 can be downloaded to persistent storage 608 through communications unit 610.

I/O interface(s) 612 allows for input and output of data with other devices that can be connected to computing system 600. For example, I/O interface 612 can provide a connection to external devices 618 such as a keyboard, keypad, a touch screen, and/or some other suitable input device. External devices 618 can also include portable computer readable storage media such as, for example, thumb drives, portable optical or magnetic disks, and memory cards.

Display 620 provides a mechanism to display data to a user and can be, for example, a computer monitor.

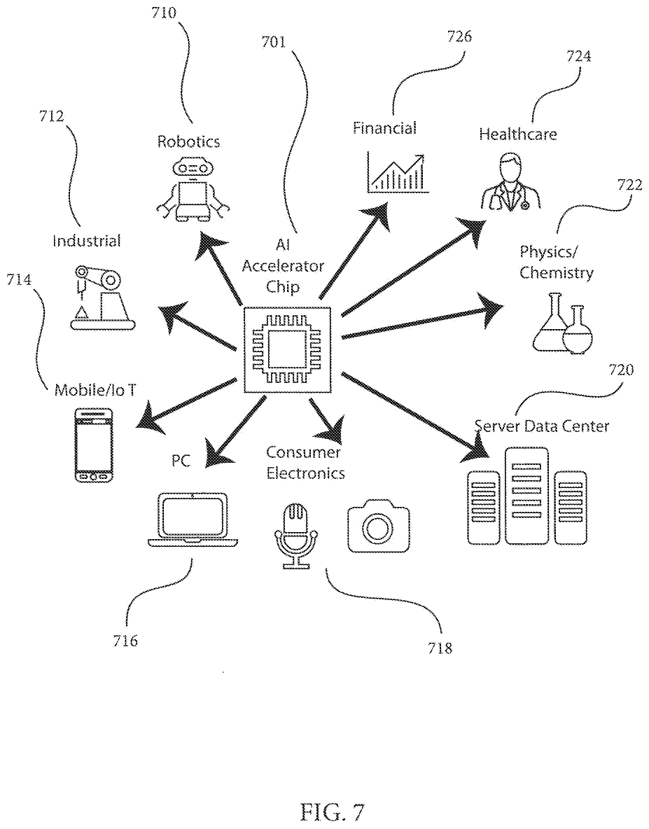

FIG. 7 illustrates practical applications for employing the DVAE via an AI accelerator chip, in accordance with an embodiment of the present invention.

The artificial intelligence (AI) accelerator chip 701 can be used in a wide variety of practical applications, including, but not limited to, robotics 710, industrial applications 712, mobile or Internet-of-Things (IoT) 714, personal computing 716, consumer electronics 718, server data centers 720, physics and chemistry applications 722, healthcare applications 724, and financial applications 726.

For example, Robotic Process Automation or RPA 710 enables organizations to automate tasks, streamline processes, increase employee productivity, and ultimately deliver satisfying customer experiences. Through the use of RPA 710, a robot can perform high volume repetitive tasks, freeing the company's resources to work on higher value activities. An RPA Robot 710 emulates a person executing manual repetitive tasks, making decisions based on a defined set of rules, and integrating with existing applications. All of this while maintaining compliance, reducing errors, and improving customer experience and employee engagement.

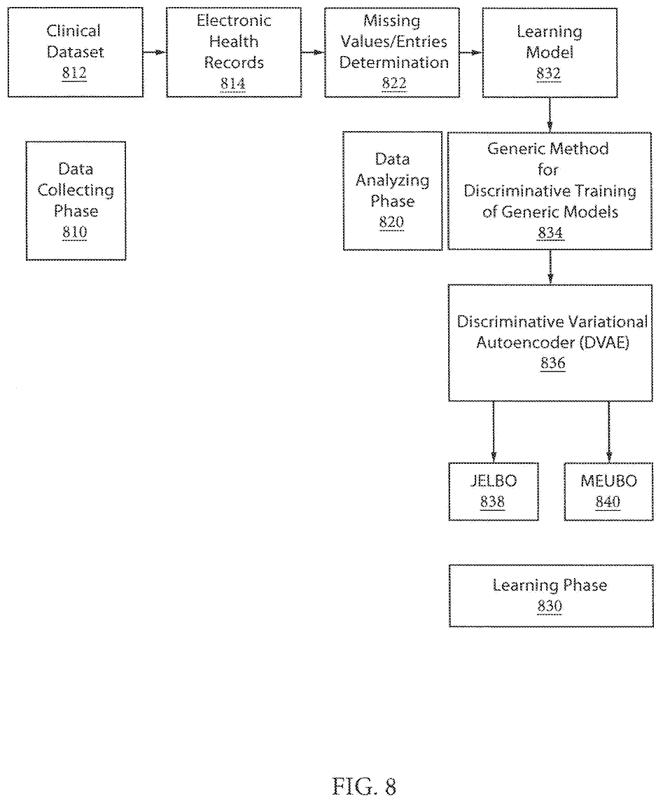

FIG. 8 is a block/flow diagram of a practical application including health care records for employing the DVAE via the AI accelerator chip, in accordance with an embodiment of the present invention.

In a data collecting phase 810, a clinical dataset 812 includes electronic health records (EHR) 814. In a data analyzing phase 820, the missing values or entries are determined at block 822. In a learning phase 830, a learning model 832 is employed, the learning model 832 using a generic method for discriminative training of generic models in block 834 that utilizes a discriminative variational autoencoder (DVAE) 836. The DVAE 836 computes JELBO 838 and MEUBO 840.

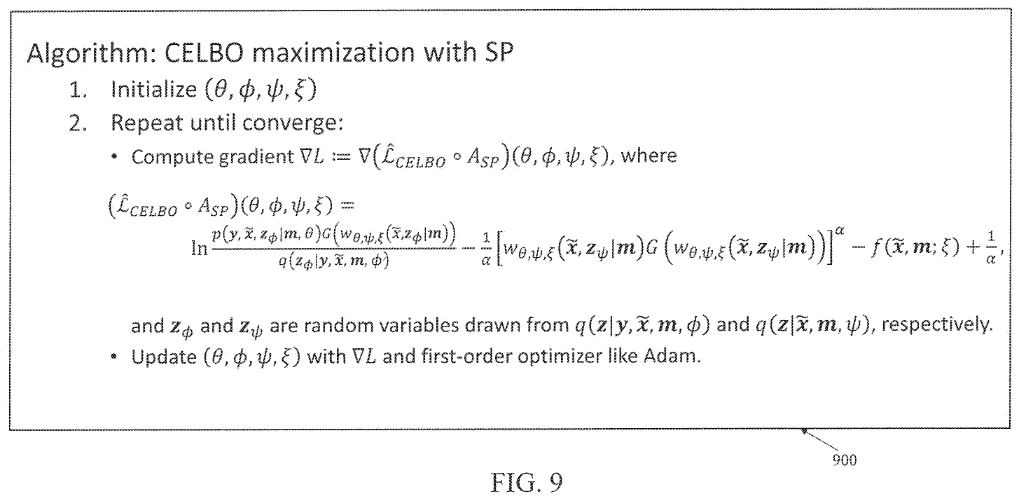

FIG. 9 is a diagram illustrating an algorithm 900 for CELBO maximization with Surrogate Parameterization, in accordance with an embodiment of the present invention.

Note: It becomes DVAE+SP if (θ, ϕ, ψ, ξ) are implemented with NNs such that:

p(y,\tilde{x},z|m,θ)=p(z)p(y|θ_{y}(z,m))p(x|θₓ(z,m)),

q(z|y,\tilde{x},m,ϕ)=q(z|ϕ(y,\tilde{x},m)),

q(z|\tilde{x},m,ψ)=q(z|ψ(\tilde{x},m)).

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for learning with incomplete data in which some of entries are missing, comprising:
acquiring an incomplete set of covariates x̅ including incomplete features \tilde{x} and an incomplete pattern m indicating missing entries of the incomplete set of covariates \tilde{x}; and
obtaining, by a hardware processor, a predictive distribution p_{θ}(y|x̅) of an outcome y by using the incomplete set of covariates x̅ and a parameter θ, the parameter θ being unknown,
wherein a learning of the parameter θ includes performing a maximization by maximizing a stochastically approximated conditional evidence lower bound, and where the stochastically approximated conditional evidence lower bound includes a density ratio which is controlled by transforming a portion of parameters of the stochastically approximated conditional evidence lower bound to keep a gradient of the stochastically approximated conditional evidence lower bound below a threshold during the maximization.

2. The computer-implemented method of claim 1, wherein the incomplete set of covariates \tilde{x}represent patient measurements taken from hardware based patient-interactive medical devices.

3. The computer-implemented method of claim 1, further comprising limiting a number of covariates per patient in the incomplete set of covariates \tilde{x}.

4. The computer-implemented method of claim 1, wherein the outcome y is a prediction time of an adverse medical event requiring medical intervention.

5. The computer-implemented method of claim 1, wherein a computation of the predictive distribution p_{θ}(y|x̅) is performed by maximizing an objective function [symbol] (θ):=ln p_{θ}(y| x̅)=−ln p_{θ}(\tilde{x}|m)+ln p_{θ}(y, \tilde{x}|m), and the objective function [symbol] (θ) is bounded with a difference between an evidence upper bound [symbol] _{EUBO} and an evidence lower bound [symbol] _{ELBO}, where ln p_{θ}(\tilde{x}|m)≤ [symbol] _{EUBO}, ln p_{θ}(y, \tilde{x}|m)≥ [symbol] _{ELBO}, and instead of the objective function [symbol] (θ), a conditional evidence lower bound [symbol] _{CELBO}(θ, ϕ, ψ, ξ):= [symbol] _{ELBO}(θ, ϕ)− [symbol] _{EUBO}(θ, ψ, ξ)≤ [symbol] (θ) is maximized, and wherein m is a mask vector indicating missing entries of \tilde{x}.

6. The computer-implemented method of claim 1, wherein the stochastically approximated conditional evidence lower bound is stochastically approximated with
$${\hat{ℒ}}_{CELBO} ( θ , ϕ , ψ , ξ ) := ln \frac{p ( y , \tilde{x} , {z}_{ϕ} \vert m , θ )}{q ( {z}_{ϕ} \vert y , \tilde{x} , m , ϕ )} - {\frac{1}{α} [ \frac{p ( \tilde{x} , {z}_{ψ} \vert m , θ )}{q ( {z}_{ψ} \vert \tilde{x} , m , ψ ) {e}^{f ( \tilde{x} , m ; ξ )}} ]}^{α} - f ( \tilde{x} , m ; ξ ) + \frac{1}{α} ,$$
wherein z is a latent variable of a variational autoencoder, q_{ϕ}(z|y, x̅)=q(z|ϕ(y, x̅)) is a conditional density function defined by a neural network ϕ to be trained together with the parameter θ, q_{ψ}(z|x̅)=q(z|ψ(x̅)) is a conditional density function defined by a neural network ψ to be trained together with the parameter θ, ξ is a surrogate network, α is a fixed real number greater than 1, m is a mask vector indicating missing entries of \tilde{x}, and z_{ϕ} and z_{ψ} are random variables drawn from q(z|y, \tilde{x}, m, ϕ) and q(z|\tilde{x}, m, ψ), respectively.

7. The computer-implemented method of claim 1, wherein for the portion of the second term of [symbol] _{CELBO}(θ, ϕ, ψ, ξ), the density ratio
$${w}_{θ , ψ , ξ} ( \tilde{x} , z \vert m ) := \frac{p ( \tilde{x} , z \vert m , θ )}{q ( z \vert \tilde{x} , m , ψ ) {e}^{f ( \tilde{x} , m ; ξ )}} ,$$
variables (θ, ϕ, ψ, ξ) are changed to (θ′, ϕ, ψ, ξ′) so that the resultant density ratio w_{θ′, ψ, ξ′}(\tilde{x}, z|m) stabilizes the maximization of the stochastically approximated CELBO.

8. A computer program product for learning with incomplete data in which some of entries are missing, the computer program product comprising a non-transitory computer readable storage medium having program instructions embodied therewith, the program instructions executable by a computer to cause the computer to perform a method comprising:
acquiring, by a hardware processor of the computer, an incomplete set of covariates x̅ including incomplete features \tilde{x} and an incomplete pattern m indicating missing entries of the incomplete set of covariates \tilde{x}; and
obtaining, by the hardware processor, a predictive distribution p_{θ}(y|x̅) of an outcome y by using the incomplete set of covariates x̅ and a parameter θ, the parameter θ being unknown,
wherein a learning of the parameter θ includes performing a maximization by maximizing a stochastically approximated conditional evidence lower bound, and where the stochastically approximated conditional evidence lower bound includes a density ratio which is controlled by transforming a portion of parameters of the stochastically approximated conditional evidence lower bound to keep a gradient of the stochastically approximated conditional evidence lower bound below a threshold during the maximization.

9. The computer program product of claim 8, wherein the incomplete set of covariates \tilde{x}represent patient measurements taken from hardware based patient-interactive medical devices.

10. The computer program product of claim 8, further comprising limiting a number of covariates per patient in the incomplete set of covariates \tilde{x}.

11. The computer program product of claim 8, wherein the outcome y is a prediction time of an adverse medical event requiring medical intervention.

12. The computer program product of claim 8, wherein a computation of the predictive distribution p_{θ}(y|x̅) is performed by maximizing an objective function [symbol] (θ):=ln p_{θ}(y|x̅)=−ln p_{θ}(\tilde{x}|m)+ln p_{θ}(y, \tilde{x}|m), and the objective function [symbol] (θ) is bounded with a difference between an evidence upper bound [symbol] _{EUBO} and an evidence lower bound [symbol] _{ELBO}, where ln p_{θ}(\tilde{x}|m)≤ [symbol] _{EUBO}, ln p_{θ}(y, \tilde{x}|m)≥ [symbol] _{ELBO}, and instead of the objective function [symbol] (θ), a conditional evidence lower bound [symbol] _{CELBO}(θ, ϕ, ψ, ξ):= [symbol] _{ELBO}(θ, ϕ)− [symbol] _{EUBO}(θ, ψ, ξ)≤ [symbol] (θ) is maximized, and wherein m is a mask vector indicating missing entries of \tilde{x}.

13. The computer program product of claim 8, wherein the stochastically approximated conditional evidence lower bound is stochastically approximated with [symbol] _{CELBO}(θ, ϕ, ψ, ξ):=ln
$$\frac{p ( y , \tilde{x} , {z}_{ϕ} \vert m , θ )}{q ( {z}_{ϕ} \vert y , \tilde{x} , m , ϕ )} - {\frac{1}{α} [ \frac{p ( \tilde{x} , {z}_{ψ} \vert m , θ )}{q ( {z}_{ψ} \vert \tilde{x} , m , ψ ) {e}^{f ( \tilde{x} , m ; ξ )}} ]}^{α} - f ( \tilde{x} , m ; ξ ) + \frac{1}{α} ,$$
wherein z is a latent variable of a variational autoencoder, q_{ϕ}(z|y, x̅)=q(z|ϕ(y, x̅)) is a conditional density function defined by a neural network ϕ to be trained together with the parameter θ, q_{ψ}(z|x̅)=q(z|ψ(x̅)) is a conditional density function defined by a neural network ψ to be trained together with the parameter θ, ξ is a surrogate network, α is a fixed real number greater than 1, m is a mask vector indicating missing entries of \tilde{x}, and z_{ϕ} and z_{ψ} are random variables drawn from q(z|y, \tilde{x}, m, ϕ)) and q(z|\tilde{x}, m, ψ), respectively.

14. The computer program product of claim 8, wherein for the portion of the second term of [symbol] _{CELBO}(θ, ϕ, ψ, ξ), the density ratio
$${w}_{θ , ψ , ξ} ( \tilde{x} , z \vert m ) := \frac{p ( \tilde{x} , z \vert m , θ )}{q ( z \vert \tilde{x} , m , ψ ) {e}^{f ( \tilde{x} , m ; ξ )}} ,$$
variables (θ, ϕ, ψ, ξ) are changed to (θ′, ϕ, ψ, ξ′) so that the resultant density ratio w_{θ′, ψ, ξ′}(\tilde{x}, z|m) stabilizes the maximization of the stochastically approximated CELBO.

15. A computer processing system for learning with incomplete data in which some of entries are missing, comprising:
a memory device for storing program code; and
a hardware processor operatively coupled to the memory device for running the program code to:
acquire an incomplete set of covariates x̅ including incomplete features \tilde{x} and an incomplete pattern m indicating missing entries of the incomplete set of covariates \tilde{x}; and
obtain a predictive distribution p_{θ}(y|x̅) of an outcome y by using the incomplete set of covariates x̅ and a parameter θ, the parameter θ being unknown,
wherein a learning of the parameter θ includes performing a maximization by maximizing a stochastically approximated conditional evidence lower bound, and where the stochastically approximated conditional evidence lower bound includes a density ratio which is controlled by transforming a portion of parameters of the stochastically approximated conditional evidence lower bound to keep a gradient of the stochastically approximated conditional evidence lower bound below a threshold during the maximization.

16. The computer-implemented method of claim 15, wherein the incomplete set of covariates \tilde{x}represent patient measurements taken from hardware based patient-interactive medical devices.

17. The computer-implemented method of claim 15, wherein the hardware processor further runs the program code to limit a number of covariates per patient in the incomplete set of covariates \tilde{x}.

18. The computer-implemented method of claim 15, wherein the outcome y is a prediction time of an adverse medical event requiring medical intervention.

19. The computer-implemented method of claim 15, wherein the hardware processor further runs the program code to perform a computation of the predictive distribution p_{θ}(y|x̅) by maximizing an objective function [symbol] (θ):=ln p_{θ}(y|x̅)=−ln p_{θ}(\tilde{x}|m)+ln p_{θ}(y, \tilde{x}|m), and the objective function [symbol] (θ) is bounded with a difference between an evidence upper bound [symbol] _{EUBO} and an evidence lower bound [symbol] _{ELBO}, where ln p_{θ}(\tilde{x}|m)≤ [symbol] ELBO, ln p_{θ}(y, \tilde{x}|m)≥ [symbol] _{ELBO}, and instead of the objective function [symbol] (θ), a conditional evidence lower bound [symbol] _{CELBO}(θ, ϕ, ψ, ξ):= [symbol] _{ELBO}(θ, ϕ)− [symbol] _{EUBO}(θ, ψ, ξ)≤ [symbol] (θ) is maximized, and wherein m is a mask vector indicating missing entries of \tilde{x}.

20. The computer-implemented method of claim 15, wherein the stochastically approximated conditional evidence lower bound is stochastically approximated with
$${\hat{ℒ}}_{CELBO} ( θ , ϕ , ψ , ξ ) := ln \frac{p ( y , \tilde{x} , {z}_{ϕ} \vert m , θ )}{q ( {z}_{ϕ} \vert y , \tilde{x} , m , ϕ )} - {\frac{1}{α} [ \frac{p ( \tilde{x} , {z}_{ψ} \vert m , θ )}{q ( {z}_{ψ} \vert \tilde{x} , m , ψ ) {e}^{f ( \tilde{x} , m ; ξ )}} ]}^{α} - f ( \tilde{x} , m ; ξ ) + \frac{1}{α} ,$$
wherein z is a latent variable of a variational autoencoder, q_{ϕ}(z|y, x̅)=q(z|ϕ(y, x̅)) is a conditional density function defined by a neural network ϕ to be trained together with the parameter θ, q_{ψ}(z|x̅)=q(z|ψ(x̅)) is a conditional density function defined by a neural network ψ to be trained together with the parameter θ, ξ is a surrogate network, α is a fixed real number greater than 1, m is a mask vector indicating missing entries of \tilde{x}, and z_{ϕ} and z_{ψ} are random variables drawn from q(z|y, \tilde{x}, m, ϕ) and q(z|\tilde{x}, m, ψ), respectively.
